(19) United States
(12) Patent Application Publication
(10) Pub. No.: US 2006/0036702 A1
(43) Pub. Date: Feb. 16, 2006

(54) Personal notification device

(76) Inventor: Gerhard Kurt Theimer, Boca Raton, FL (US)

Correspondence Address: GERHARD KURT THEIMER, 19583 HAVENSWAY CT., BOCA RATON, FL, 33498, US

(21) Appl. No.: 10/884,437

(22) Filed: Jul. 2, 2004

(51) Int. Cl. G06F 15/16

(52) U.S. Cl. 709/207

(57) ABSTRACT

A personal notification device for providing messaging and alert services from a plurality of different sources, compromising a hardware device with integrated display, a suitable connection method to a computer and appropriate software applications. -The different sources can include one or more business productivity programs, such as electronic mail, a spreadsheet, online auction, weather services, server monitoring programs, manufacturing machines, office equipment, or personal information manager software application, as well a messaging service that produces alerts transmitted over the Internet. The personal notification device provides an improved method to receive messages and alerts without requiring the user to be at or near a computer. The personal notification device can be physically placed at the users discretion to best facilitate his requirements. The personal notification device can be utilized for a multitude of applications by simply loading and activating software modules.

### CROSS-REFERENCE TO RELATED APPLICATIONS

Not Applicable

### FEDERAL SPONSORED RESEARCH

Not Applicable

### SEQUENCE LISTING OF PROGRAM

Not Applicable

### BACKGROUND OF THE INVENTION—FIELD OF INVENTION

The present invention relates generally to computer peripherals, specifically to a personal notification device and its related software.

### BACKGROUND OF THE INVENTION—PRIOR ART

A computing device, such as a desktop computer or laptop computer, may have several different software applications or services that produce alerts or notifications, which pop-up on a display screen to provide information or a reminder to a user.

Connection of computing devices to the Internet has greatly expanded the range and types of possible notifications and alerts that may be displayed to a user. The form of these alerts or notifications and the manner in which they appear on a user's display screen is generally determined by the designers of the software applications that produce them. There is clearly a benefit for a user of a computing device to receive information of potential value and to be reminded of the approach of a scheduled time to carry out a task. However, there is a need to better display the various kinds of notifications and alerts that are presented to a user.

It should be possible for a user to view alerts from a variety of different sources, based on his own preferences even if he or she is not near or at the computer. Currently, there is no provision in any application or operating system to drive a separate notification device to present notifications and alerts from different sources. By providing a personal notification device, users should be able to more efficiently access the information and reminders provided thereby and not be confused by a variety of different formats and functionalities for presenting the notifications and alerts.

Many software programs generate visible and audible signals to alert the user of a certain condition. Examples are electronic mail (email) programs, surveillance and control programs like online auction programs, programs that monitor stock portfolios, programs that monitor other computers, programs that monitor machines and devices among many other applications.

The audible signal is normally generated by the computer sound system and heard through a build-in or external speaker. The visible signal is normally displayed on the. computers monitor in a wide variety of ways.

Status messages presented in this manner, such as an alert for an incoming electronic mail, have the disadvantage that the user needs to be near or at the computer to recognize the alert. If he or she is not at the computer at the time of the alert, the user must actively look for potential messages when returning to the computer.

Another disadvantage is, that the audible alert signal is only given a single time. In case the user did not hear the audible signal, he or she may miss a message.

Another major disadvantage of the current method of user notification is, that users are also notified if the message is not important or not even requested. A typical example is spam and unsolicited mail. Since electronic mail is normally read when the computer alerts, time and resources are spend to retrieve the messages, only to find out that they are of no importance. It becomes apparent that this procedure leads to productivity losses because of work interruption and the time requirement to read and delete the mail.

The common disadvantage of all programs that generate on-screen and or audible alerts when a preset condition is met is, that the user is required to be at or near the computer at the time of the notification.

Another disadvantage of current notification methods comes apparent when a “screen-saver” progranm is active. In order to prevent burn-in effects to a monitor, user selected or random images and graphics are normally displayed. When a “screen-saver” program is active, on-screen messages can not be seen.

In order to receive notifications, the often resource intensive applications, need to run all the time taking away memory and processing power, while potentially adding instability to a computer system.

### OBJECTS AND ADVANTAGES OF THE INVENTION

Accordingly, the primary object of the present invention is to provide a personal notification device, without the disadvantages of previous methods.

My invention consists of a core software application, additional software modules and a hardware indicator device, the personal notification device. The personal notification device is connected to a computer data port via a suitable connection method. The data port may be widely varied. For example, the data port may be a PS/2 port, a serial port, a parallel port, a USB port, a FireWire port, and the like. In some cases, the data port may be a radio frequency (RF) link or optical infrared (IR) link to eliminate the need for a cable.

The personal notification device, now referred to as PND, incorporates high intensity light emitting diodes, the necessary electronics to drive them, and a interface chip that provides communication services to the host computer. The light emitting diodes, controlled through the core software and the software modules, light up when certain user defined conditions are met.

The PND can be placed on the users desk, or mounted on a tripod or flexible arm. This allows the user to position the PND in a way that it can be seen from across a room or office. This creates a very convenient way to observe the PND from a distant.

Another object of the invention is to provide an open software architecture that allows the integration of software modules to expand the functionality of the invention. The open software architecture allows for software modules that are tailored for specific notification requirements. Software modules can either be purchased or developed by the user. This way, the invention can provide notification services for a multitude of uses.

Several objects and advantages of the present invention are:

(a) That it does not require the user to be in front of the computer in order to recognize notifications and or alerts.

(b) It is not limited in its range of application. It can be utilized for a wide variety of uses, by loading and activating an appropriate software module. By way of example, the module for electronic mail, online auctions, portfolio monitoring, server computer supervision and much more.

(c) That it requires only minimal resources on the host computer.

(d) That the notification hardware device can be placed on the users desk in a way to be seen from all directions, from across are room or office.

(e) That it can be incorporated into existing computer peripherals like computer enclosures and computer monitors.

Further objects and advantages of the invention will become apparent from a consideration of the flowchart, the drawings and ensuing description.

Accordingly, besides the objects and advantages of the PND described above, further objects and advantages of the present invention are:

(a) To provide a hardware device which can be produced in a variety of colors to match the users preferences.

(b) To provide a PND which allows for a time and resource efficient operation.

(c) To provide a PND which allows messages to be perceived even if the user is not in front of the computer.

(d) To provide a PND which can be expanded by the use of software modules to allow for a wide range of applications and uses.

The core software is used to provide a graphical user interface to load (install) and select (activate) software modules that in turn provide the appropriate notification services. Software modules for a wide range of applications are available. The open architecture also allows for the easy integration of user-developed applications.

Software modules may have so called preference panels. The user utilizes preference panels to define and fine tune the available notification services of a individual module.

As an example on how a software module can work, the electronic mail notification module is explained. After loading and activating the email module, the user opens the email preference panel. Here, the user defines which email accounts will be monitored by the module. Next, the user adds email addresses to the module from which he wishes to receive email notifications.

Each email address or a group of email addresses can be assigned to either one of the three light emitting diodes (LED) of the inventions PND.

By way of example, one light could be assigned to customers email addresses, another light to coworker addresses and yet another light to personal email addresses like family addresses etc. Further, the user can decide if the LEDs should turn on solid or flash or a combination thereof when messages come in.

After closing the preference panel, the module will poll the defined email accounts, in user selectable intervals. The users main email application, the one he uses to retrieve and read messages, is not required to run.

As soon as a new email arrives, the address of the originator will be compared to the ones defined in the preference panel. If the originator email address is not defined (not in the list of accepted addresses) no notification is given.

Consequently an address that is in the user-defined list, will trigger the appropriate light. In addition, an on-screen animation and an audible signal is generated, if so selected by the user. Additionally a dismiss button is displayed on screen.

The user now has the option to click on the on-screen animation, which will open the users email application, to retrieve and read the incoming mail, or click on the dismiss button which will cancel the on-screen notification and turns off all lights of the PND. The dismiss button is used to cancel any notification in case that user does not want to be disturbed or is not interested to retrieve announced message at this time.

The notification method of the present invention assures, that the user only receives email notification for predefined addresses. All other email will not trigger the PND. By using this method, the eMail module helps to accomplish other tasks in an uninterrupted workilow, without missing important information.

Another example scenario is on-line auctions. After loading and activating the auction module, by using the core software, the user can assign the lights to certain operations through the preference panel. A light (LED) can be assigned for example to “received a bit”, “being outbid”, “article has been posted” and many other conditions. As soon as the module preferences are set, the module will start monitoring one or more auctions automatically. User defined notification is given automatically, without the need for constant user supervision, as is required when performing this task conventionally.

Many different software modules can be used with the same PND, making it a universal tool to display status information and alerts.

The PND also facilitates an integrated tripod mount, allowing it to be mounted on standard tripods, flexible arms and other mounting systems. This gives the user total flexibility to place the PND.

### SUMMARY OF THE INVENTION

The present invention relates to improved approaches for users of computing devices to interact with status and alert information. According to one aspect of the invention, email can be presented in a unique way, not interrupting the users workflow. This is a welcomed ease of use.

According to another aspect of the invention, status information of an extended list of items, i.e. online auctions, can be clearly indicated on the PND, without requiring the user to monitor his computer screen.

According to another aspect of the invention, status information generated by appropriate software module can be clearly indicated on the PND, without requiring the user to monitor his computer screen.

According to another aspect of the invention, the PND can be physically placed at the users discretion to best facilitate his requirements. Therefore, freeing the user from his computer screen without losing touch with important status, alert and other information.

### DRAWINGS—FIGURES

The present invention is illustrated by way of example, and not by way of limitation, in the figures of the accompanying drawings and in which like reference numerals refer to similar elements and in which:

FIG. 1 is a BLOCK DIAGRAM, showing the hardware and software components of the invention and their relation to the user and the users computer.

FIG. 2 is a PERSPECTIVE DRAWING of the personal notification device, in accordance with the preferred embodiment of the present invention.

FIG. 3a is a TOP VIEW DRAWING of the personal notification device, in accordance with the preferred embodiment of the present invention.

FIG. 3b is a SIDE VIEW DRAWING of the personal notification device, in accordance with the preferred embodiment of the present invention.

FIG. 3c is a FRONT VIEW DRAWING of the personal notification device, in accordance with the preferred embodiment of the present invention.

FIG. 4 is a SIDE VIEW DRAWING of the lens component of the personal notification device, in accordance with the preferred embodiment of the present invention.

FIG. 4a is a SIDE VIEW DRAWING of the intermediate cover component of the personal notification device, in accordance with the preferred embodiment of the present invention.

FIG. 4b is a SIDE VIEW DRAWING of the printed circuit board component of the personal notification device, in accordance with the preferred embodiment of the present invention.

FIG. 4C is a SIDE VIEW DRAWING of the enclosure component of the personal notification device, in accordance with the preferred embodiment of the present invention.

FIG. 5a is a PERSPECTIVE DRAWING (FRONT) of the personal notification device, in accordance with the preferred embodiment of the present invention.

FIG. 5b is a PERSPECTIVE DRAWING (REAR) of the personal notification device, in accordance with the preferred embodiment of the present invention.

FIG. 6 is a PERSPECTIVE DRAWING (FRONT) of a computer monitor in accordance with another embodiment of the present invention.

FIG. 7 is a PERSPECTIVE DRAWING (FRONT) of a portable wireless device in accordance with another embodiment of the present invention.

### DRAWINGS—REFERENCE NUMERALS

1. Enclosure
2. Lens Cover
3. Light Emitting Diode (LED)
4. Connection Cable
5. Tripod
6. Tripod Socket
7. Monitor/Screen
8. Liquid Crystal Display
9. Printed Circuit Board
10. Intermediate Cover
11. Response Button
12. Thumb Screw
13. Opening for Cable
14. Cavity for LED
15. Light Emitting Diode (LED)
16. Enclosure
17. Speaker or Buzzer
18. Antenna
19. Liquid Crystal Display
20. Response Button
21. Light Emitting Diode (LED)

### DETAILED DESCRIPTION—PREFERRED EMBODIMENT

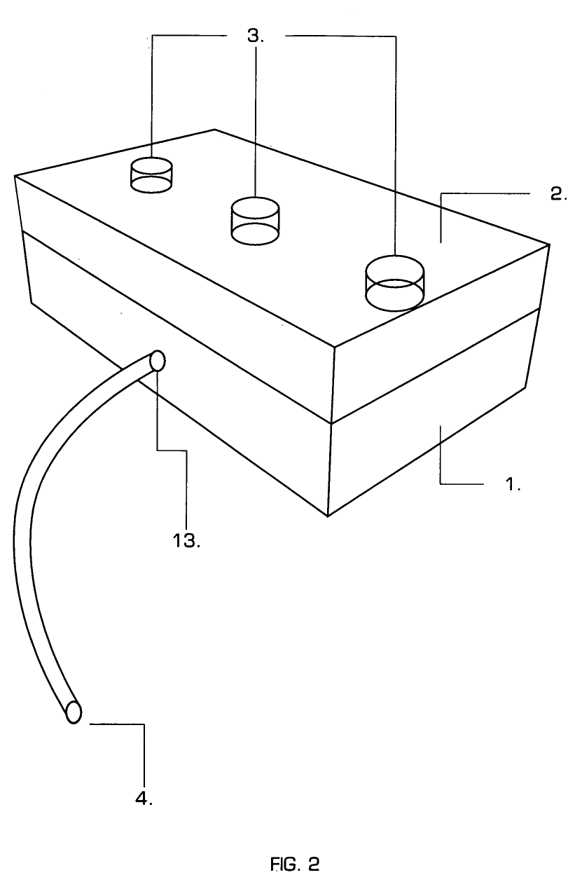

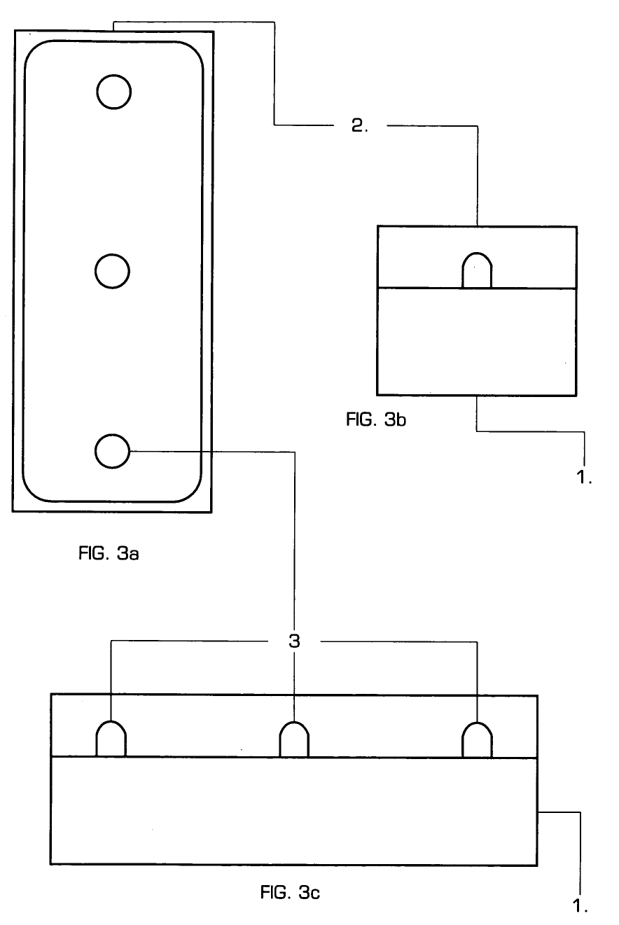

A preferred embodiment of the PND is illustrated in FIG. 2 (perspective view) and FIG. 3a (top view), FIG. 3b (side view) and FIG. 3C (front view).

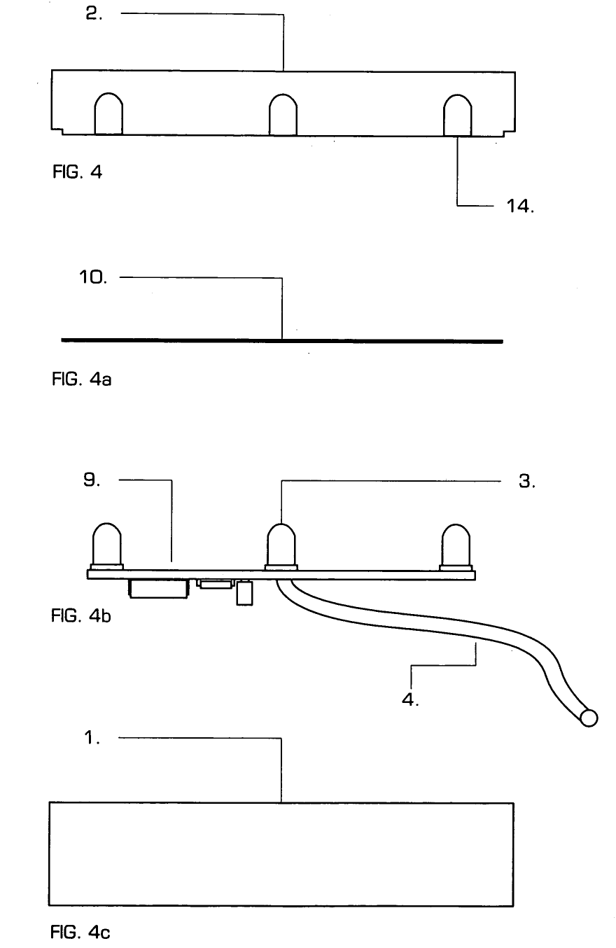

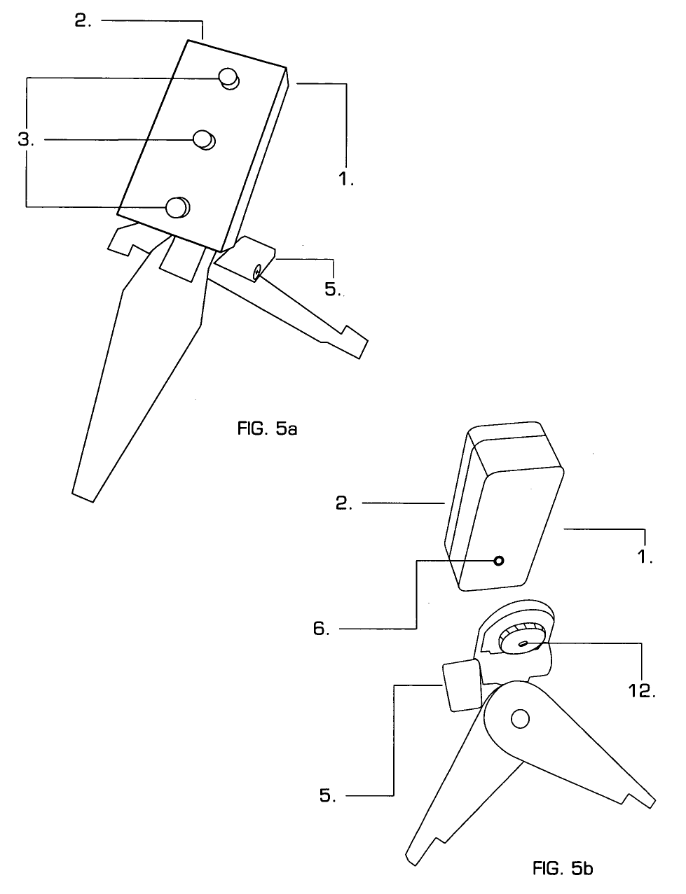

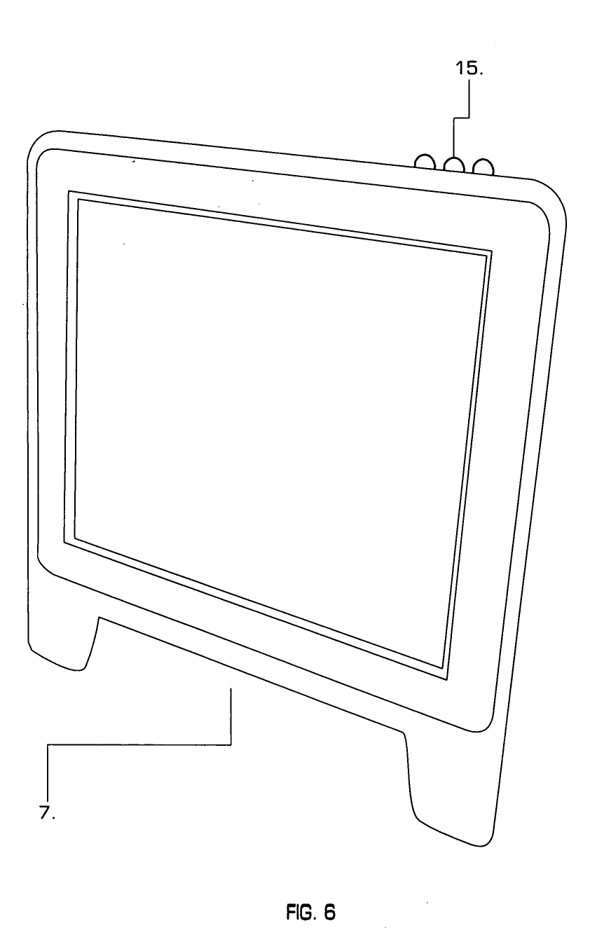

As illustrated in FIG. 4, the preferred embodiment consists of four main components. Lens (2.), Intermediate Cover (10.), Printed Circuit Board (9.) and the Enclosure (1).

The lens (2.) component as illustrated in FIG. 4 (side view) is used to provide protection for the light emitting diodes (3.) by utilizing a cavity (14.) in the lens, and to distribute their light in all directions. It is made out of optically transparent plastic material.

The intermediate cover (10.) component as illustrated in FIG. 4a (side view) is used to cover the printed circuit board (9.) from view. It also acts as a reflective material to amplify the light of the light emitting diodes (3.). It is made out of opaque, reflective plastic material.

The printed circuit board (9.) component as illustrated in FIG. 4b (side view) contains the necessary electronic components to communicate with the core software, the software modules and the users computer and to drive the three ligHt emitting diodes (3.). A cable (4.) is used to make the physical connection to the users computer.

The enclosure (1.) component as illustrated in FIG. 4c (side view) provides space for circuit board (9.) and the intermediate cover (10.) The lens component (2.) snaps into the enclosure to complete the unit. The enclosure is made out of metal with an appropriate opening (13.) for the connection cable (4.)

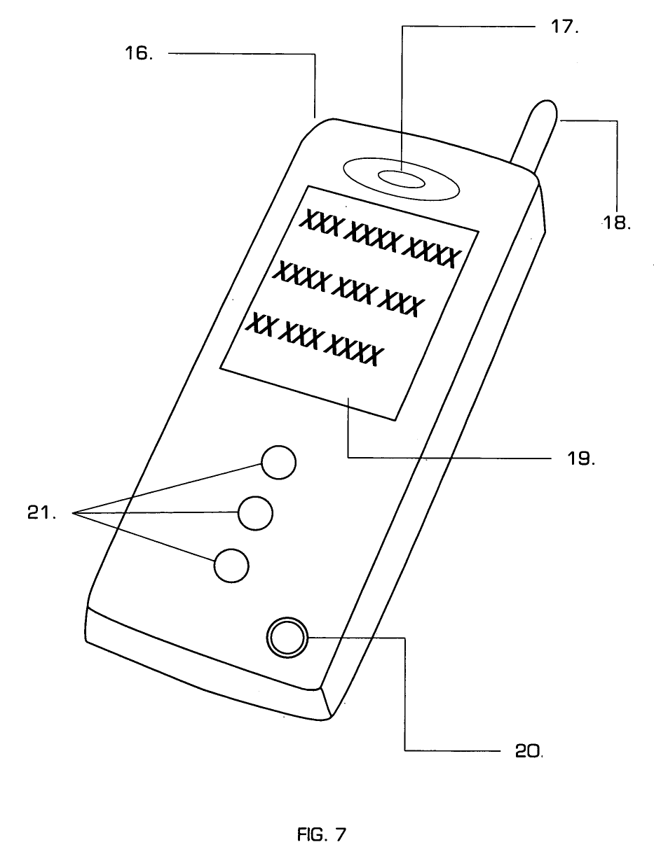

The enclosure (1.) also contains a standard tripod socket (6.) on its backside. The tripod socket (6.) is shown in FIG. 5b. This allows the user to mount the PND to a mounting device, a flexible arm or a tripod (5.) as illustrated in FIG. 5a and FIG. 5b. This way the user can place the PND for an optimal viewing position.

Operations

My invention consists of a core software application, additional software modules and an indicator device, the PND. The PND is connected to a computer data port via a suitable connection method. The hardware part of the invention, as shown in FIG. 2, consists of an enclosure (1.) which incorporates the electronics (not visible), an intermediate cover (not visible), a transparent lens (2.) with three integrated color coded light emitting diodes (3.), an opening for the connection cable (13.) and the connection cable (4.).

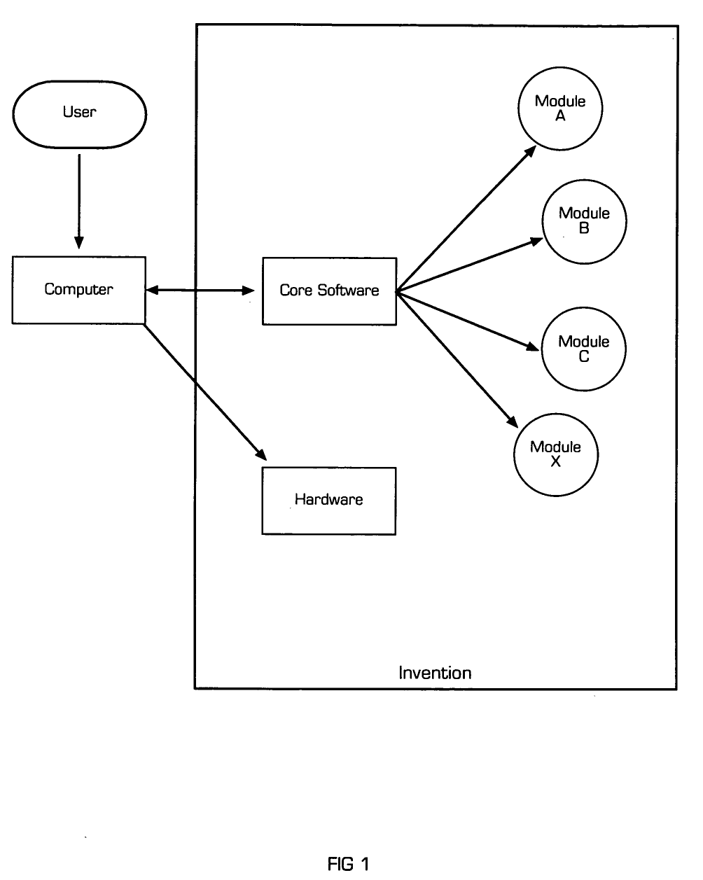

The software application is a resource efficient software program, which runs unobtrusively in the background. This is the core application that is used to load and activate software modules. Modules are by themselves software programs that are actually providing the functionality of the invention. The use of modules allows for further expansion and adaptation of the invention to a wide variety of uses and applications, while providing a standardized user interface through the core software. FIG. 1 shows the application of this open software architecture.

One available module is the eMail Module. I will explain the method and concept of the invention by example of the eMail module.

In a typical office environment electronic mail is one of the means of communication. In order to send and receive electronic mail, an email client software must be installed and running on a users computer. In intervals the users mailbox is polled for new messages by this program. In case a new message arrives, the computer will announce the message optically and or audibly. In many cases the user is either not directly at the computer, i.e. doing other desk work, or is busy with a different software application on the same computer. In either case, the user usually interrupts his current duty in order to read the new incoming mail.

Reading the message will interrupt the users current workflow. Besides the time and the resources spend to access and read the mail, the line-of-thought may be lost when returning to the original duty. Additionally the user has no way of knowing in advance, if the incoming mail was important or unsolicited.

My invention solves this problem by letting the user assign email addresses or groups of email addresses to either one of the (3.) light emitting diodes.

After loading and activating the email module, the user opens the modules preference panel. Here, the user defines which email accounts the module will monitor. Next, the user adds email addresses to the module from whom he wishes to receive email notifications. Each email address or a group of email addresses can be assigned to either one of the three light emitting diodes (3.) on the PND. Further, the user can decide if the LEDs should turn on solid or flash or a combination thereof when messages come in.

By way of example, one light could be assigned to customers email addresses, another light to coworker addresses and yet another light to personal email addresses like family addresses.

After closing the preference panel, the module will poll all defined email accounts, in an intervall set by the user. The users main email application, the one he uses to retrieve and read messages, is not running at this time.

As soon as a new message comes in, the senders address will be compared to the ones defined in the preference panel. If the sender email address is not defined (not in the list of accepted addresses) no notification is given. Consequently if an address is on the list, it will trigger the appropriate light. In addition, a on-screen animation, the dismiss button and a audible signal is generated, if so selected by the user in the preference panel.

The user now has the option to click on the on-screen animation, which will open the users email application, to retrieve and read the incoming mail, or dismiss the notification by pressing a user definable key on the keyboard.

The notification method of the invention assures, that the user only receives notification when electronic mail from predefined addresses arrive. All other eMails will not trigger the PND. By using this method, the eMail module helps to accomplish other tasks in an uninterrupted workflow, without missing important information at the same time.

The email module is only one of many ways to utilize the notification device. Modules for various tasks are available or can be created to match individual requirements.

5. Alternative Embodiments:

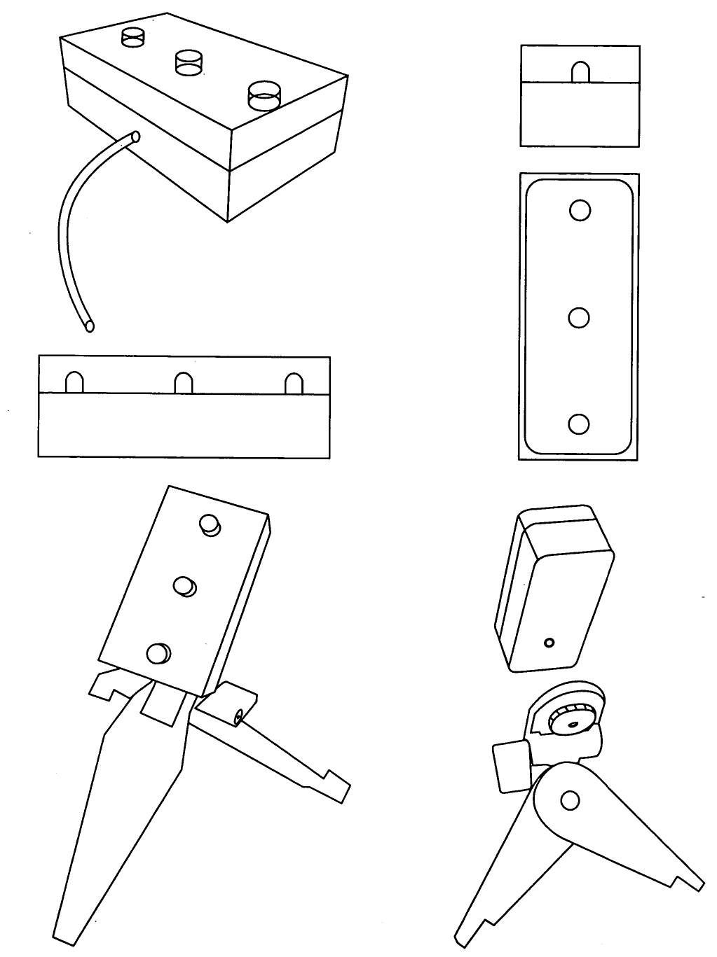

The invention can be implemented in numerous ways, including as a method, system, device or apparatus. Embodiments of the invention are discussed below with reference to FIGS. 6 to 7. However, those skilled in the art will readily appreciate that the detailed description given herein with respect to these figures are for explanatory purposes as the invention extends beyond these limited embodiments.

Monitor/Screen Integration:

FIG. 6 is a perspective diagram of a monitor (7.) in accordance with another embodiment of the invention. Integrated into the monitor (7.) is the necessary electronic circuitry to communicate with the software modules and the users computer and to drive the optical notification hardware.

Typically, the electronic circuitry includes a microprocessor, memory, I/O controller, etc. The monitor housing (7.) also provides the space for the optical notification hardware, in this example, three light emitting diodes (15.)

The integration of the optical notification hardware into a computer monitor or display screen has the advantage of eliminating a connection cable.

Another advantage is, that no desk real estate is needed for an additional hardware device.

The integration of the invention into the monitor housing (7.) may also define the shape or form of the monitor housing. That is, the contour of the housing may embody the outward physical appearance of the notification system, i.e. light emitting diodes, LCD displays or other notification hardware, allowing for an aesthetically pleasing design.

Operation

The main difference to the preferred embodiment lies in the different integration of the hardware. Operation of this embodiment is as described in the operation section of the preferred embodiment.

Wireless, Portable Device:

FIG. 7 is a perspective diagram of a housing (16.) in accordance with another embodiment of the invention. The housing encloses various electrical components (including integrated circuit chips and other electronic circuitry) to provide computing capabilities for the notification device. The integrated circuit chips and other circuitry may include a microprocessor, memory (e.g., ROM or RAM), a power source (e.g., a battery), a circuit board, a hard drive, a speaker (17.), an antennae for wireless communication (18.), a LOD screen (19.), a piezo buzzer, vibration alarm, three light emitting diodes (21.), an acknowledge button (20.) and various input/output (I/O) support circuitry.

In this embodiment, the present invention is a handheld device that is sized for placement into a pocket of the user (i.e., pocket-sized) or on his belt. By being pocket-sized, the user does not have to directly carry the device and therefore the device can be taken anywhere within the reach of the wireless network environment. One clear advantage is, that the user is not limited by carrying a large, bulky and often heavy device, such as a portable computer plus the external PND.

In this embodiment, the present invention has wireless connection capabilities that allow a user to upload and receive data to and from a host device such as a server computer, general purpose computer (e.g. desktop computer or portable computer).

Operation

In this embodiment, the present invention incorporates additional features and advantages. The light emitting diodes (21.) will notify the user of incoming messages and alerts as described in the operation section of the preferred embodiment. Additionally a vibrating alarm can be triggered if the unit is carried in a pocket. Incoming messages will also be displayed on the integrated LCD display (19.)

A special feature of this embodiment is the acknowledge button (20.) The acknowledge button (20.) allows a user to interact with a computer program (software module, application program or operating system) performed by the host computer system. The main function of the acknowledge button is to allow the user to confirm an incoming message or alert. The user confirmation is send back wirelessly to the appropriate software module. The software module will put a time stamp (time and date) on the acknowledgment for further processing on the host computer or server computer. This feature is especially of value when user feedback is required or needs to be recorded.

Pressing the acknowledge button (20.) may also trigger audio feedback to the user to confirm that the button has been pressed. The controller for the associated piezoelectric buzzer or speaker (17.) can, for example, be a the processor of the portable device, or some other circuitry coupled to the piezoelectric buzzer or speaker.

The main difference to the preferred embodiment lies in the different integration of the hardware. By providing a portable device, the user does not have to look at the desktop PND to visually check for messages and alerts, instead messages and alerts are delivered Tirelessly to the portable PND.

Operation of this embodiment is as described in the Operation section of the preferred embodiment.

Conclusion, Ramification, Scope

Although the description above contains many specifities, these should not be construed as limiting the scope of the invention but merely providing illustrations of some of the presently preferred embodiments of this invention. For example, the enclosure can have other shapes, such as circular, oval, trapezoidal, triangular etc.; the hardware can also be integrated into existing designs such as monitors or computer enclosures.

The many features and advantages of the present invention are apparent. from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

Thus, the scope of the invention should be determined by the appended claims and their legal equivalents, rather than by the examples given.

The primary object of the present invention is to provide a personal notification device, without the disadvantages of previous methods.

By providing a user friendly, easy to use and resource efficient yet expandable software architecture with a graphical interface, and a unique hardware solution, the present innovation provides numerous advancements and advantages over existing solutions. The advantages of the invention are numerous. Different embodiments or implementations may yield one or more of the following advantages. It should be noted that this is not an exhaustive list and there may be other advantages that are not described herein.

One of the advantages is, that the user is not required to be at his computer to receive messages and alerts since the notification lights can be seen from a distance. The module for electronic mail has the advantage, among others, that notification is only given if electronic mail from a pre-selected addresse arrives. This provides the user with the unique ability to concentrate on his work in an environment that is uninterrupted from unsolicited or otherwise currently unwanted electronic mail. This feature is especially useful for businesses were work interruption and time spent to retrieve and read electronic mail can lead to productivity losses.

An example makes this fact clear. If a user checks his electronic mail on average three times an hour, and spends just one minute per check, a total time of 24 minutes is spend on a typical 8 hour work day. This adds up to 5×24=120 minutes per week or 8 hours per month. This example demonstrates that an entire workday of productivity could be regained by the use of the present invention. It is easy to project this type of savings to an entire office staff.

Another advantage of the present invention is, that it is not limited in its range of application. It can be utilized for a wide variety of uses, like electronic mail, online auctions, portfolio monitoring, security applications, server supervision and much more. Software modules can be made available for all conceivable applications and thanks to the open software architecture of the core software, modules are easily loaded and activated.

Another advantage of the present invention is, that it requires only minimal resources on the host computer. This frees available memory, makes the computer faster and less prone to system crashes.

Another advantage of the present invention is, that the notification hardware device of the preferred embodiment can be placed on the users desk in a way to be seen from all directions.

Another advantage of the present invention is, that the indicator device has an integrated tripod socket, allowing it to be mounted on standard tripods, flexible arms and other mounting systems. This gives the user total flexibility in the placement of the indicator device.

Another advantage of the present invention is, that it can be incorporated into existing computer peripherals like computer enclosures, computer monitors or other display units.

According, besides the objects and advantages of the present invention described above, further objects and advantages of the present invention are:

That the PND can be produced in a variety of colors to match the users preferences.

That core software is used to provide a graphical user interface to load (install) and select software modules, which in turn provide the appropriate notification services. Software modules for a wide range of applications are available. The open architecture also allows for the easy integration of additional or user developed modules.

That the software modules may have so called preference panels. Preference panels are used, to define and fine-tune the available notification services of the individual software module, by the user.

That many different software modules can be used with the PND, making it a universal notification tool.

Thus, there is always a need for improved user information systems that facilitate greater ease of use of computer software and information generated thereof.

I claim:

1. A personal notification device compromising:
A. A enclosure that contains the electronic circuitry;
B. A display to indicate arrival of messages and alerts;
C. A connection method to a computer data port;
D. An application software to drive the personal notification device.

2. A method for interacting with a graphical user interface produced on a display device of a computing device, said method comprising:
A. Displaying and activating available software modules;
B. Selecting software modules associated with a user input action;
C. Converting the user selection into a output signal depending on software selectable conditions; and
D. Displaying the user selected action on the display device of a computing device and on the personal notification device.

3. A method for mounting the personal notification device, said method comprising a tripod socket.

4. A personal notification as recited in claim 1, wherein said display compromises one or more light emitting diodes.

5. A personal notification as recited in claim 1, wherein said display is a liquid crystal display.

6. A personal notification device as recited in claim 1, wherein said connection method to a computer port may be via a PS/2 port, a serial port, a parallel port, a USB port, a FireWire port, and the like. The data port may also be a radio frequency (RF) link or optical infrared (IR) link.

7. A personal notification device as recited in claim 1, wherein said application software is modular in design for easy adaptation to different applications.

8. A personal notification device as recited in claim 1, wherein said enclosure can be manufactured in different colors to adapt to the users preferences.

9. A method as recited in claim 2, wherein said computing device is a general-purpose computer.
